(19) United States
(12) Patent Application Publication
(10) Pub. No.: US 2025/0168660 A1
(43) Pub. Date: May 22, 2025

(54) OVERALL NETWORK PERFORMANCE EFFECTIVENESS DEVICE CONFIGURED TO IMPROVE NETWORK PERFORMANCE

(71) Applicant: Belden Inc., St. Louis, MO (US)

(72) Inventors: Michael S. FISHER, Cambridge (CA); Aravind Rajendra KUMAR, Lasalle (CA)

(73) Assignee: Belden Inc., St. Louis, MO (US)

(21) Appl. No.: 18/951,240

(22) Filed: Nov. 18, 2024

Related U.S. Application Data
(60) Provisional application No. 63/600,467, filed on Nov. 17, 2023.

(51) Int. Cl. H04W 24/02; H04W 24/08

(52) U.S. Cl. CPC H04W 24/02; H04W 24/08

(57) ABSTRACT

An overall network performance effectiveness improvement device that is configured to improve overall network performance based on a network availability level, a network capacity level, and/or a network quality level. The device may be configured to receive network availability data, network capacity data, and network quality data and calculate a network availability level, a network capacity level, and a network quality level based on such network availability data, network capacity data, and network quality data, to determine whether the calculated overall network performance effectiveness level is below a predetermined threshold overall network performance effectiveness level, and to cause a network improvement control event that is configured to improve overall network performance effectiveness of the network if the overall network performance effectiveness level is below a predetermined threshold overall network performance effectiveness level.

### CROSS REFERENCE TO RELATED APPLICATION

This application claims priority to U.S. Provisional Patent Application No. 63/600,467, filed on Nov. 17, 2023, the disclosure of which is incorporated herein by reference in its entirety.

### TECHNICAL FIELD

The present disclosure generally relates to an overall network effectiveness (ONE) device. More specifically, the overall network effectiveness device may calculate an overall network performance effectiveness level, value or factor to provide feedback for improving the overall network performance effectiveness of the network.

### BACKGROUND

Modern networks are pervasive and broad reaching. Performance impacts on such networks can be crippling. Management and monitoring of such networks often involves qualifying and quantifying performance and recognizing any issues that require corrective action. Corrective actions for critical failures, such as a device or connection going “offline”, are often simpler to recognize then corrective actions to resolve systemic issues, such as periodic saturation of network links. This makes establishing key performance indicators (KPIs) to assess the status, health, and effectiveness of a network important difficult.

Due to the variety of network media, styles, types, topologies and underlying requirements in use, it may be difficult for a network management system or network administrators & technicians to evaluate the health of a network in such a way that can be objectively scored, consistently evaluated, simple to understand and easy to apply. This problem is exacerbated by the complicated nature of networks with numerous possible metrics for evaluation, the difficulty in benchmarking performance, and the wildly differing scale of such networks. For example, the effectiveness of the network may be directly related to operational output of users of the network.

Accordingly, there is a need for an overall network effectiveness device that is able to provide an overall network effectiveness for various types and sizes of networks that provides objective indicators of overall network effectiveness while being easy to understand and apply while providing effective feedback for improving network effectiveness when needed.

### SUMMARY

According to embodiments of the disclosure, an overall network performance effectiveness improvement device improves overall network performance based on a network availability level, a network capacity level, and a network quality level. The device includes an overall network performance effectiveness improvement controller having overall network performance effectiveness improvement program instructions stored in a memory device. The overall network performance effectiveness improvement controller is configured to receive network availability data, network capacity data, and network quality data regarding a network and calculate a network availability level, a network capacity level, and network quality level based on such network availability data, network capacity data, and network quality data. the overall network performance effectiveness improvement controller is configured to calculate an overall network performance effectiveness level of the network based on the calculated network availability level, the calculated network capacity level, and the calculated network quality level. The overall network effectiveness level is determined based on the calculated network availability level times the calculated network capacity level times the calculated network quality level. The overall network performance effectiveness improvement controller is configured to determine whether the calculated overall network performance effectiveness level is below a predetermined threshold overall network performance effectiveness level. The calculated network availability level comprises an available time link level that is configured to be available for use by the network during operation divided by an expected time link level that is expected to be available for use by the network during operation. The calculated network capacity level comprises an unutilized network port utilization percentage of an unutilized port level of the network relative to a utilized network port level of the network.

wherein the calculated network quality level comprises functional network packets received divided by total network packets received; The overall network performance effectiveness improvement controller is configured to cause a network improvement control event that is configured to improve overall network performance effectiveness of the network if the overall network performance effectiveness level is below a first predetermined threshold overall network performance effectiveness level. The first predetermined threshold overall network performance effectiveness level comprises an overall network performance effectiveness level indicative of an enhanced network performance level that is greater than the calculated overall network performance effectiveness level. The overall network performance effectiveness improvement controller is configured to receive updated network availability data, updated network capacity data, and updated network quality data regarding the network as a result of the network improvement control event, and calculate an updated network availability level, an updated network capacity level, and an updated network quality level based on the updated network availability data, the updated network capacity data, and the updated network quality data; The overall network performance effectiveness improvement controller is configured to calculate an updated overall network performance effectiveness level of the network based on the updated network availability data, the updated network capacity data, and the updated network quality data. The overall network performance effectiveness improvement controller is configured to cause an updated network improvement control event that is configured to improve overall network performance effectiveness of the network if the updated overall network performance effectiveness level is below a second predetermined threshold overall network performance effectiveness level.

According to embodiments of the disclosure, an overall network performance effectiveness improvement device improves overall network performance based on a network availability level, a network capacity level, and a network quality level. The overall network performance effectiveness improvement device includes an overall network performance effectiveness improvement controller configured to receive network availability data, network capacity data, and network quality data regarding a network and calculate a network availability level, a network capacity level, and a network quality level based on such network availability data, network capacity data, and network quality data. The overall network performance effectiveness improvement controller is configured to calculate an overall network effectiveness level of the network based on the calculated network availability level, the calculated network capacity level, and the calculated network quality level. The overall network performance effectiveness improvement controller is configured to determine whether the calculated overall network performance effectiveness level is below a predetermined threshold overall network performance effectiveness level. The calculated network availability level comprises an available time link level that is configured to be available for use by the network during operation divided by expected time link level that is configured to be expected to be available for use by the network during operation. The calculated network capacity level comprises an unutilized network port utilization percentage of unutilized ports of the network relative to utilized ports of the network. The calculated network quality level comprises functional network packets received divided by total network packets received. The overall network performance effectiveness improvement controller is configured to cause a network improvement control event that is configured to improve overall network performance effectiveness of the network if the overall network performance effectiveness level is below a predetermined threshold overall network performance effectiveness level.

According to embodiments of the disclosure, an overall network performance effectiveness improvement device improves overall network performance based on a network availability level, a network capacity level, and a network quality level. The device includes an overall network performance effectiveness improvement controller configured to receive network availability data, network capacity data, and network quality data regarding a network and calculate a network availability level, a network capacity level, and a network quality level based on such network availability data, network capacity data, and network quality data. The overall network performance effectiveness improvement controller is configured to calculate an overall network performance effectiveness level of the network based on the calculated network availability level, the calculated network capacity level, and the calculated network quality level. The overall network performance effectiveness improvement controller is configured to determine whether the calculated overall network performance effectiveness level is below a predetermined threshold overall network performance effectiveness level. The overall network performance effectiveness improvement controller is configured to cause a network improvement control event that is configured to improve overall network performance effectiveness of the network if the overall network performance effectiveness level is below a predetermined threshold overall network performance effectiveness level.

The overall network effectiveness device may also be embodied in the form of a non-transitory computer readable medium configured to be utilized by a processor to carry out the functionality described herein. Various embodiments also include methods for carrying out improved performance of the network.

### BRIEF DESCRIPTION OF THE DRAWINGS

Further advantages and features of the present disclosure will become apparent from the following detailed description and the accompanying drawings.

FIG. 1 illustrates an overall network device and a network in accordance with various aspects of the disclosure.

FIG. 2 illustrates an overall network device in accordance with various aspects of the disclosure.

FIG. 3 illustrates a formula for determining an overall network effective level for a network in accordance with various aspects of the disclosure.

FIG. 4 illustrates a flowchart for determining an overall network effective level for a network in accordance with various aspects of the disclosure.

FIG. 5 illustrates a flowchart for determining an overall network effective level for a network in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

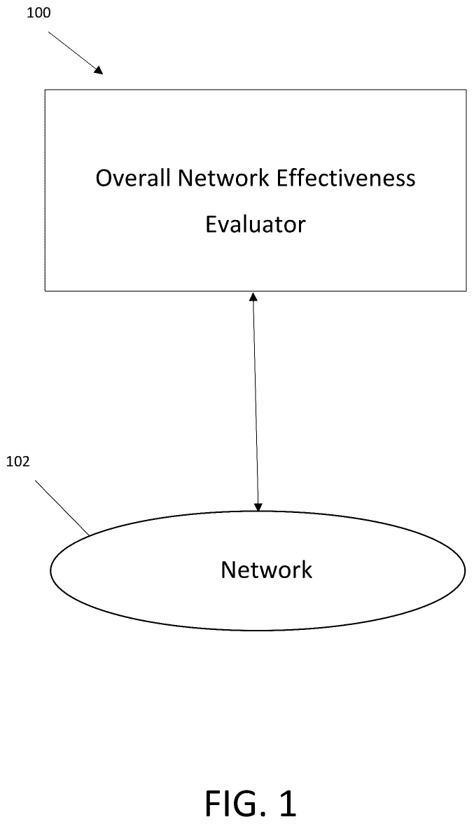

FIG. 1 illustrates an exemplary embodiment that may be used in conjunction with the aspects disclosed herein. In FIG. 1, an overall network effectiveness or ONE device, evaluator, processor, or controller 100 is illustrated. The ONE device 100 may be connected to a network 102. The device 100 also may be configured to determine an overall network effectiveness (ONE) level, factor, or value of the network. In various embodiments, the overall network effectiveness level, factor, or value calculated by the device 100 is configured to be used to improve the overall network effectiveness of the network 102 by improving various types of network performance, such as regarding connectively, capacity, quality, etc., as further explained herein.

The ONE device 100 may be adjacent to the network such as a network management software which runs on a computerized end-device (that may be connected to a switch or otherwise connected to the network), or it could be incorporated into a network infrastructure device like the switch itself which effectively embeds the ONE device within the network being evaluated.

The ONE device 100 is configured to improve technology in the area of networks by determining a ONE level, value or factor of the network, which is a measure of network performance, comparing the ONE level, value or factor to a threshold ONE level, value, or factor and initiating corrective action to the network to improve network performance when the ONE level, value or factor is below the threshold ONE level, value or factor. The device thus allows network administrators to easily keep network performance at a enhanced level through the corrective action or improvement event and be advised when network performance may have issues.

In some embodiments, the ONE level, factor, or value compared to a predetermined threshold ONE range (instead of to a predetermined threshold ONE level, factor, or value) and initiating corrective action to the network to improve network performance when the ONE level, factor, or value is beyond the predetermined threshold ONE range.

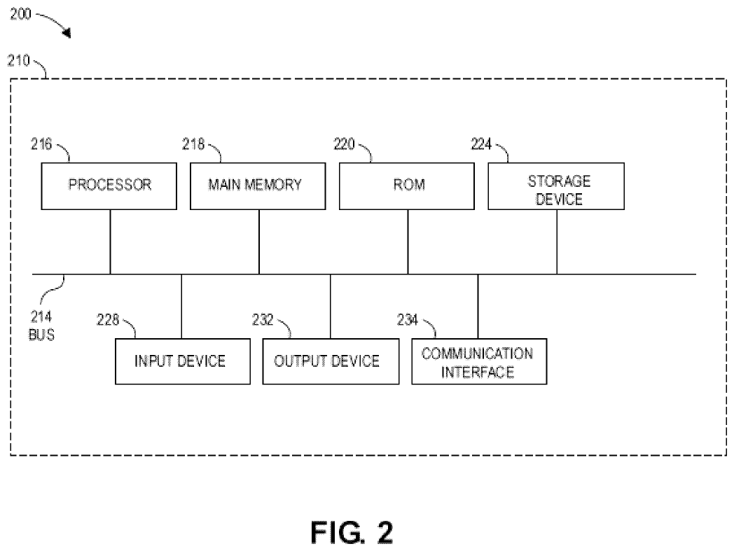

FIG. 2 illustrates an exemplary embodiment that may be used in conjunction with the aspects disclosed herein. FIG. 2 is a system block diagram illustrating an example of further details of the ONE device 100 of FIG. 1, which may be in the form of a computing system in accordance with aspects of the present disclosure. As shown in this example, the ONE device 200 includes a computing device 210 that is configured to communicate via a network, such as the Internet. In some embodiments, the device 200 may be connected directly to network 102. In various embodiments, the computing device 210 may correspond to a mobile communications device (e.g., a smart phone or a personal digital assistant (PDA)), a portable computer device (e.g., a laptop or a tablet computer), a desktop computing device, a server, a network infrastructure device (e.g. a switch or a firewall), etc. In some embodiments, the computing device 210 may host programming and/or application(s) to carry out the determination of the overall network effectiveness of network 102 as described herein.

In some embodiments, the computing device 210 may include a bus 214, a processor 216, a main memory 218, a read only memory (ROM) 220, a storage device 224, an input device 228, an output device 232, and a communication interface 234. Bus 214 may include a path that permits communication among the components of device 210. Processor 216 may be or include a processor, a microprocessor, an application specific integrated circuit (ASIC), a field programmable gate array (FPGA), or another type of processor that interprets and executes instructions. Main memory 218 may include a random access memory (RAM) or another type of dynamic storage device that stores information or instructions for execution by processor 216. ROM 220 may include a ROM device or another type of static storage device that stores static information or instructions for use by processor 216. Storage device 224 may include a magnetic storage medium, such as a hard disk drive, or a removable memory, such as a flash memory.

Input device 228 may include a component that permits an operator to input information to device 210, such as a control button, a keyboard, a keypad, or another type of input device. Output device 232 may include a component that outputs information to the operator, such as a light emitting diode (LED), a display, or another type of output device. Communication interface 234 may include any transceiver-like component that enables device 210 to communicate with other devices or networks. In some implementations, communication interface 234 may include a wireless interface, a wired interface, or a combination of a wireless interface and a wired interface. In embodiments, communication interface 234 may receive computer readable program instructions from a network and may forward the computer readable program instructions for storage in a computer readable storage medium (e.g., storage device 224).

ONE device 200 may perform certain operations, as described in detail below. For instance, ONE device 200 may perform these operations in response to processor 216 executing software instructions contained in a computer-readable medium, such as main memory 218. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 218 from another computer-readable medium, such as storage device 224, or from another device via communication interface 234. The software instructions contained in main memory 218 may direct processor 216 to perform processes that will be described in greater detail herein. Alternatively, hardwired circuitry may be used in place of or in combination with software instructions to implement processes described herein. Thus, implementations described herein are not limited to any specific combination of hardware circuitry and software. In some implementations, overall network effectiveness device 200 may include additional components, fewer components, different components, or differently arranged components than are shown in FIG. 2.

The ONE device 200 may be connected directly to network 102 or may be connected to network 102 through an intermediate network, such as a communications network (not shown), which may include one or more wired and/or wireless networks. For example, the network may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), a wireless fidelity (Wi-Fi) network (e.g. IEEE 802.11, IEEE 802.11b, IEEE 802.11a, IEEE 802.11g, IEEE 802.11n, IEEE 802.11ac, IEEE 802.11ax, IEEE 802.11be, or the like) and/or another network. Additionally, or alternatively, the network may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the communications network may include copper transmission cables, optical transmission fibers, wireless transmission, routers, firewalls, switches, gateway computers and/or edge servers.

Embodiments disclosed herein are configured to obtain data from the network and the data is used to determine an overall network effectiveness level, value or factor for the network. The overall network effectiveness level, value or factor may be used to improve the overall network effectiveness of the network. In some embodiments, the ONE device 100, 200 may be configured to provide feedback, including the overall network performance effectiveness level, factor, or value, to the network (or to users of the network). The overall network performance effectiveness level, factor, or value may be configured to be useable to improve the overall network effectiveness of the network, or to provide indications of particular components of the network that are causing a low ONE level, factor or value, which may be utilized to improve the overall network effectiveness of the network, such as by initiating corrective action to the network.

The ONE device, which alternatively may be referred to as a ONE processor, controller, or device, may be applied to any scale of network including networks with a single hop (i.e., 1 switch). This means that the ONE device can be embedded within an individual network attached device in addition to network management and analytics software. Conventional devices may only place any network health indicators within an upper management layer and may not put an evaluation engine in the network infrastructure or in-field devices.

In some embodiments, the overall network effectiveness level, value or factor may be a numeric indicator configured to be indicative of the overall network effectiveness of the network being evaluated. The overall network effectiveness level, value or factor may be objectively scored, applicable to any network and consistently evaluated. The overall network effectiveness level, value or factor could also be depicted graphically as in a chart or gauge.

Various network factors may be utilized in determining the overall network effectiveness level, value or factor. These factors may include connection availability, port utilization, network congestion, device uptime, channel interference, packet errors, varying speeds, legacy devices, redundancies, and bandwidth capacity. The overall network effectiveness level, value or factor may be agnostic of factors including vendor, ISO layer, device age, network topology and network industry.

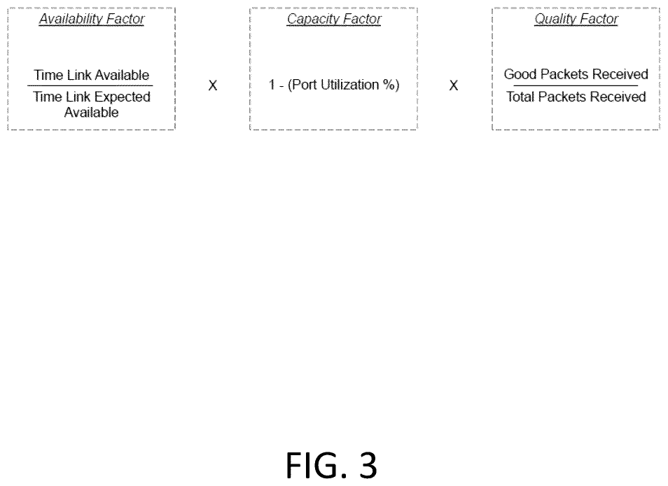

In some embodiments, the overall network effectiveness level, value or factor for a given network link may be determined as illustrated in FIG. 3 from values of Availability Factor (AF)×Capacity Factor (CF)×Quality Factor (QF), AF×CF×QF=ONE. The Availability Factor AF may be determined as Network Time Links Available/Network Time Links Expected Available, the Capacity Factor CF may be determined as the unutilized Network Port Utilization percentage %, and the Quality Factor QF may be determined as Good Network Packets Received/Total Network Packets Received. The levels, values or factors for the Availability factor, the Capacity Factor and the Quality Factor may all be obtained or measured from the network being evaluated.

In some embodiments, the overall network effectiveness level, value or factor may be determined using two or more of the Availability Factor, the Capacity Factor and the Quality Factor. In some embodiments, the calculations to determine the ONE level, value or factor may be performed in agent software within the network. In some embodiments, the calculations to determine the ONE level, value or factor may be performed in a switch in the network. In some embodiments, the calculations to determine the ONE level, value or factor may be performed in a processor external to the network. In some embodiments, the calculations to determine the ONE level, value or factor may be performed by an Al system.

In some embodiments, the Network Port Utilization % may be determined as the bps received/negotiated bandwidth. In some embodiments, the Quality Factor may be determined as total packets received-received CRC Errors-received Collisions/total packets received.

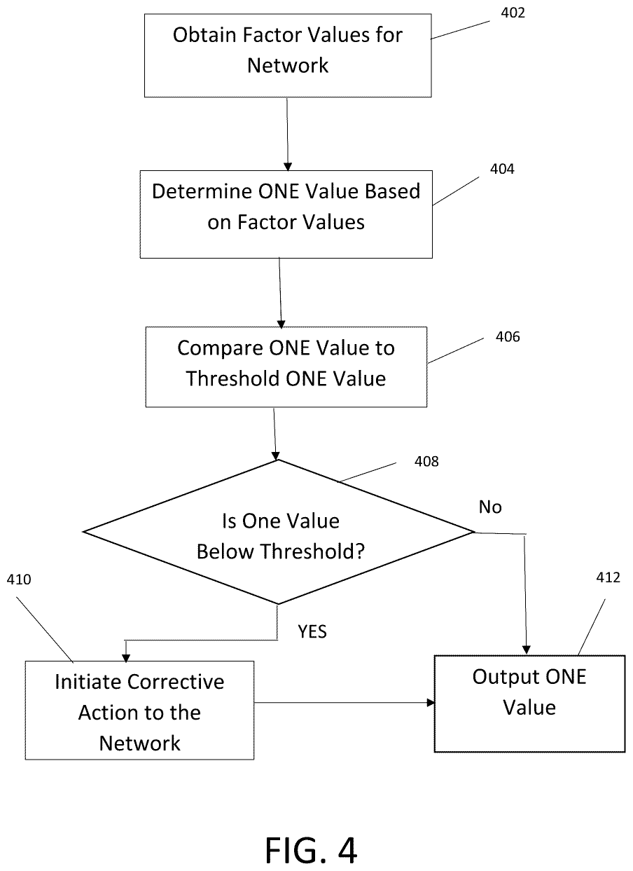

FIG. 4 illustrates a flowchart of a process for determining an overall network effectiveness level, value or factor for a network to improve network performance in accordance with various embodiments. In 402, the Availability Factor, the Capacity Factor and the Quality Factor are obtained from the network. In some embodiments, the overall network device may be configured to obtain (by collecting or otherwise obtaining) the raw input data used for determining the factors.

In some embodiments, a plurality of ONE devices may be utilized to each determine an overall network performance effectiveness level, value or factor for a portion of a network. The ONE devices may be strung together so that devices higher in a network do not need to determine all of the factors needed for determining an overall network effectiveness level, value or factor themselves, but can rely on the determinations already done by ONE devices through the network.

In some embodiments, a determination for an instantaneous ONE level, factor, or value may be performed. An alerting mechanism may be included to alert a management agent (either a person or a system) to begin the process of determining a ONE value, level, or factor and potentially taking any needed corrective action.

In some embodiments, a ONE level, factor, or value can be determined and compared to previous ONE determinations, allowing for periodic, cyclic, or trending variations in ONE values, levels or factors, to trigger a corrective action. Additionally, threshold ONE levels, factors, or values, that may trigger corrective action may be tailored over time to reflect the natural operating state of a given network, rather than just a subjectively established value.

Trending the ONE level, factor, or value over time means that not only could there be a single One threshold for a singular determination to be compared to but that the history of ONE levels, values or factors can be analyzed for patterns and trends. Thus, corrective action can be taken for issues that aren't yet or may never be considered as “faults” or “failures”. These, “performance optimization” activities can be planned in accordance with ONE levels, values or factors for periods most suitable to the work and operating environment.

In 404, a ONE level, value, or factor for the network is determined based on the Availability factor, the Capacity Factor and the Quality Factor using the formula described in conjunction with FIG. 3. In 406, the determined ONE level, value or factor for the network being evaluated is compared to a threshold ONE level, value or factor.

In 408, it is determined whether the determined ONE level, factor, or value for the network being evaluated is below the threshold ONE level, factor, or value. If the determined ONE level, factor, or value for the network being evaluated is below the threshold ONE level, factor, or value, in 410 corrective action is initiated for the network because the overall network effectiveness needs improvement so as to improve performance of the network. If it is determined that the ONE level, value, or factor for the network being evaluated is not below the threshold ONE level, value, or factor, then the ONE level, value, or factor, for the network is strong. In 412, the ONE level, value, or factor is output to the network or network users such as an administrator and may be retained in memory.

In some embodiments, a very strong or world class target overall network effectiveness level, value or factor may be a set value, such as 90% or a range such as 75-90%. A superior or enhanced performing network may have an overall network performance effectiveness level of 75-90%. This target may be reached, for example, with AF=>98%, CF=>90% and QF=>85%. A network with a superior or enhanced performing availability may have an availability factor level of 98% or higher. A network with a superior or enhanced performing capacity may have a capacity factor level of 90% or higher. A network with a superior or enhanced performing quality may have a quality factor level of 85% or higher. However, other levels could be used for the overall network effectiveness, the availability level, value or factor, the capacity level, value or factor and the quality level, value or factor. In some embodiments, the target overall network effectiveness level, value or factor may be set to a threshold level, value or factor by a user.

In some embodiments, if a measured ONE level, value, or factor, falls below the threshold or target ONE level, value, or factor, the ONE device 100, 200 may be configured to initiate corrective action to the network to improve the overall network effectiveness level, value or factor to be above the threshold ONE level, value, or factor. The ONE device 100, 200 may be configured to initiate corrective action or cause a corrective event by determining which of the Availability Factor (“AF”), alternatively referred to as an Availability Level (“AL”) or a Availability Value (“AV”), Capacity Factor (“CF”), alternatively referred to as “Capacity Level (” CL″) or a Capacity Value (“CV”), and/or Quality Factor (“QF”), alternatively referred to as a Quality Level (“QL”) or a Quality Value (“QV”), are below the threshold Availability Factor, threshold Capacity Factor, and/or the threshold Quality Factor, respectively. The corrective action to the network may include deploying network enhancements, such as by causing a network enhancement, or transmitting a signal that causes such a network enhancement, such as by triggering a network connector, switch, link or any action or other network improvement control mechanism that is configured to manually or automatically cause the current state or configuration (e.g., capacity, availability, quality) of the network to be improved or enhanced in either static or dynamic manner based on the changing state, configuration, and/or component (e.g., improvement or improvement of one or more faulty or underperforming nodes, links, connections, switch es etc., or improving the configuration or state of the network itself) of the network over time or as a result of operational changes of the network during operation.

In some embodiments, the calculated ONE level, value, or factor may be presented to an operator who then may interpret the data (drilling down as required) and executes an appropriate corrective action, indication, or triggering event that is configured to improve the overall network capacity, performance, and/or quality accordingly. In some embodiments, the device may automatically initiate the corrective action, indication, or event to improve the overall network effectiveness by improving the overall capacity, availability, and/or quality accordingly. In both cases, as the calculated ONE level, value, or factor deviates from the threshold ONE level, value, or factor, network performance moves with it; lessening ONE level, values, or factors generally correlating to poorer network performance. Thus, corrective actions, indications or triggering events taken to improve ONE result in improvements or enhancements to network performance.

For example, a faulty network link could result in a lower availability factor, which drags down the determined ONE level, value, or factors. A network link saturated with traffic will affect the capacity factor and produce a similar affect. A mismatch in negotiated duplex settings could result in increase in packet collisions which lowers the quality factor. The ability to dissect the determined ONE level, value, or factor and drill down into the constituent factors, and trace the factors back to specific network connects allows for targeted corrective actions, indications or triggering events.

For example, corrective action may be taken by changing a network connection or setting, such as disabling a port or forcing a connection setting like the duplex negotiation which could restore the corresponding factors and improve the calculated ONE level, value, or factor. The calculated ONE level, value, or factor could be used to take corrective action to direct changes to traffic shaping through mechanisms like VLANs, routing and domain controls; isolating devices or combining them to find an optimal balance of availability, capacity, and quality as reflecting in the ONE level, value or factor.

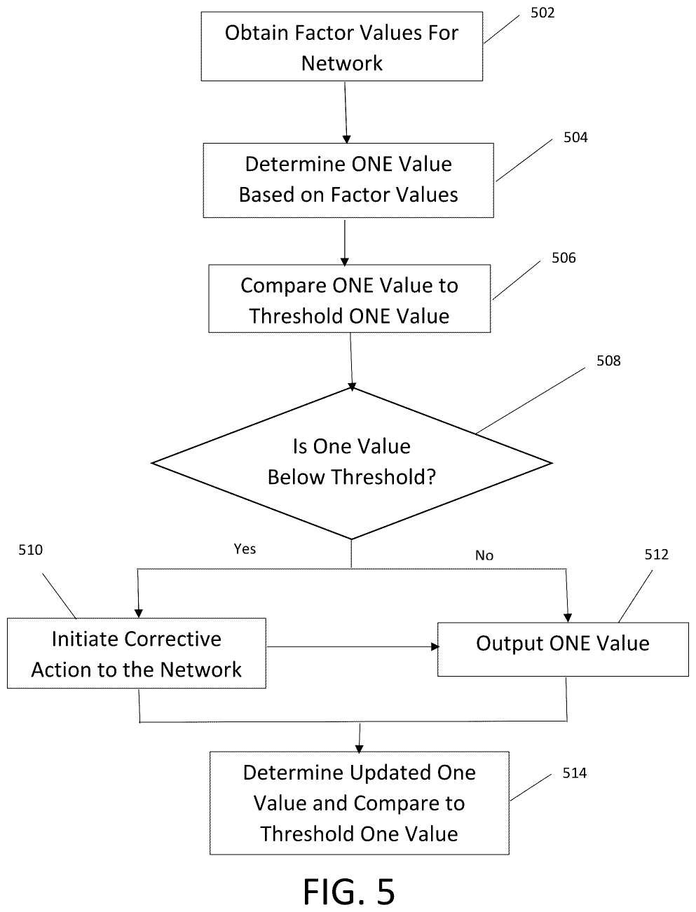

FIG. 5 illustrates a flowchart of a process for determining an overall network effectiveness level, value or factor for a network to improve network performance in accordance with various embodiments. In 502, the Availability Factor, the Capacity Factor and the Quality Factor are obtained from the network. In some embodiments, the overall network device may be configured to obtain (by collecting or otherwise obtaining) the raw input data used for determining the factors.

In 504, a ONE level, value, or factor for the network is determined based on the availability level, value or factor, the capacity level, value or factor, and the quality level, value or factor using the formula described in conjunction with FIG. 3. In 506, the determined ONE level, value, or factor for the network being evaluated is compared to a threshold ONE level, value or factor.

In 508, it is determined whether the determined ONE level, value or factor for the network being evaluated is below the threshold ONE level, value or factor. If the determined ONE level, value or factor for the network being evaluated is below the threshold ONE level, value or factor, in 510 a corrective action, indication, or triggering event is initiated for the network because the overall network effectiveness needs improvement so as to improve performance of the network. If it is determined that the ONE level, value or factor for the network being evaluated is not below the threshold ONE level, value or factor, then the ONE level, value or factor for the network is strong. In 512, the ONE level, value or factor is output to the network or network users such as an administrator and may be retained in memory.

In 514, an updated ONE level, value or factor may be determined from updated newly determined factors, such as an updated availability level, value or factor, an updated capacity level, value or factor and an updated quality level, factor or value from the network after corrective action to the network, and compared to the threshold ONE level, value or factor. In some embodiments, the One level, value or factor for the network may be determined on a regular basis so that corrective action to the network may be initiated as needed.

In some embodiments, the overall network performance effectiveness improvement controller may be configured to determine whether the calculated network availability level is below a predetermined threshold network availability level and cause a network availability improvement control event that is configured to improve network availability performance effectiveness if the calculated network availability level is below the predetermined threshold network availability level. For instance, the network availability improvement control event may include improving of connection, setting, switches, node, link, configuration and/or state of the network.

In some embodiments, the overall network performance effectiveness improvement controller may be configured to determine whether the calculated network capacity level is below a predetermined threshold network capacity level and cause a network capacity improvement control event that is configured to improve network capacity performance effectiveness if the calculated network capacity level is below the predetermined threshold network capacity level. For instance, the network capacity improvement control event may include improving connection, setting, switch, node, link, configuration and/or state of the network, for example.

In some embodiments, the overall network performance effectiveness improvement controller is configured to determine whether the calculated network quality level is below a predetermined threshold network quality level and generate a network quality improvement control event that is configured to improve network quality performance effectiveness if the calculated network quality level is below the predetermined threshold network quality level. For instance, the network quality improvement control event may include improving a connection, setting, switch, node, link, configuration and/or state of the network, for example.

In some embodiments, the overall network performance effectiveness improvement controller may be configured to compare subsequent calculated overall network performance effectiveness levels to a calculated average overall network performance effectiveness level, calculate a subsequent-to-calculated-average overall network performance effective level comparison, and cause an overall network effectiveness improvement control event that is configured to improve overall network performance effectiveness based on the calculated subsequent-to-calculated-average overall network performance effective level comparison.

Wireless systems can be particularly susceptible to issues with traffic balancing. The ONE level, value or factor can be used to take corrective action by guiding efforts in access point placement, and utilization of the various frequencies and channels allowed.

The ONE level, value or factor could be used as a trigger point for a redesign of a network or specific segments within it. Furthermore, the ONE level, value or factor could be used as a key performance indicator in simulations of a network design prior to its deployment.

The ONE level, value or factor could even be used by service agents and contractors when determining and evaluating agreements. For example, a minimum determined ONE level, value or factor could be specified in an agreement as a metric for network performance.

In some embodiments, the overall network effectiveness level, value or factor may be scalable to different scale networks. For example, the overall network effectiveness level, value or factor may be calculated per port and rolled up per switch, network segment or facility, or any other state, configuration, node, link or other enhanced state improvement mechanism, using a rollup formula of Average ONE level, value or factor minus standard deviation.

When a pool of ONE levels, values or factors to be aggregated is determined, this could relate to connections for a specific network switch, or a collection of switches within a network segment, or progressively larger network domains. The pool of ONE levels, values or factors may be aggregated using a simple average or a weighted average. If a weighting scheme is used, the individual ONE levels, values or factors are multiplied by a pre-determined weighting value ascribed to the class of connection, level of criticality to the network or operation, or other such method of definition. For example, connections including an end-device may be categorized as “end-device connections”, connections adjacent those may be categorized as “aggregation layer connections”, connections adjacent to those may be categorized as “backbone layer connections”, and each category given a different weighting value to place a stronger emphasis on the ONE relating to one category at the expense of one or more others.

In some embodiments, the overall network effectiveness level, value or factor can be weighted to preference values of the network, such as levels for End-Device Layer, (e.g., (1) connections between network end-points, levels for Aggregation Layer, (2) connections between End-Device Layers or levels for Backbone Layer, (3) connections between Aggregation Layers). Additionally, the weights may be customizable where end-users can prioritize links so ONE reflects their critical assets & operations.

The standard deviation of the pool is subtracted from the aggregated ONE level, value or factor to create the rolled-up ONE level, value or factor for that pool of network connections.

In some embodiments, software for determining the overall network effectiveness level, value or factor for a network or components thereof, comparing the overall network effectiveness level, value or factor to a predetermined threshold overall network effectiveness level, value or factor, and initiating corrective action if the determined overall network effectiveness level, value or factor is below the predetermined threshold overall network performance effectiveness level, value or factor may be included directly in the network to be evaluated or components thereof, without the need to provide a separate computing device.

In some embodiments, a system producing the ONE level, value or factor could be equipped with a graphical interface, but not necessarily. Similarly, a system producing the ONE level, value or factor could be equipped with a notification system such as a mechanism to send email, SMS, MMS, or phone call, but not necessarily.

The following lists some possible uses of the overall network performance effectiveness controller:

1. Use onboard a switch or network connected device. For example, an element in the operating firmware of a switch. This gives the ONE level, value or factor of any port on the device or the device as a whole. It would be calculated by the device itself.

2. Use within network management packages. For example, an element in a network management system that gives the same as #1 but can also roll up to encompass the entire network. A ONE level, value or factor could be calculated by the device and aggregated by the software, or if the switch doesn't provide it then it could be calculated by the software based on data from the devices.

3. Use within a data plane. For example, an element accessible via API to allow an outside tool like an AI engine to trend the data point over time. Like #2, a ONE level, value or factor could be calculated by the device and aggregated by the data plane or calculated by the data plane based on data from the devices.

The ONE level, value or factor determined by the ONE device may be used to initiate corrective action, alternatively referred to as an indication or triggering event, to the network to improve network performance. The ONE level, value or factor determined by the ONE device may be used to define which network segment(s) are experiencing an issue by identifying which network segments have an underperforming ONE. Then the ONE device and/or a user may attempt to define which device(s) in the network segment have the underperforming ONE, followed by identifying the specific connections which have the underperforming ONE. The ONE level, value or factor can then be unpacked for the source(s) of the underperformance to determine root cause which then leads to an appropriate corrective action.

For example, a team of network administrators may be tasked with supporting a facility-wide data network for an operational network. Such a system is likely to have hundreds of switches and thousands of end-devices, which means that the administrators need to monitor the status and performance of several thousand connections. Significant events like the complete failure of a primary network connection are often easy to identify as large sections of the network become unavailable. However, short duration events or ones that only result in a reduced capability of the network can, and do, go unnoticed. And events that repeat at odd intervals may not be associated with each other which makes it difficult to identify and correct the true root cause.

For example, the ONE level, value or factor of a given facility-wide network may be monitored by the ONE device over a period of time to establish a baseline under normal conditions. When the ONE lands outside this range, an alert may be generated to send a notification to network administrators for them to take action and investigate the occurrence. Should the ONE level, value or factor raise unexpectantly, drilling down into the factors may discover that the Capacity Factor has increased indicating that less traffic is flowing through the network compared with historical operating levels. Moreover, localizing the change to a set of network connections or even a specific port would allow the administrator to recognize a potential device failure or aberrant behavior that they would not have previously recognized.

More common scenarios may be a sudden drop in ONE level, value or factor such as when an abnormal amount of traffic propagates through the network, reducing the capacity factor. A localization and drill-down with ONE would allow network administrators to identify the source device(s), and then take further steps to intercept errant communications even if the total volume of traffic would have been within an allowable threshold.

It is also possible for the ONE metric to be used in automated responses to similar scenarios. For example, a drop in ONE traced back to a reduction in the Quality factor due to an increase in packet collisions may prompt a wireless system to statically or dynamically select a different channel within the spectrum or even a different spectrum entirely. Or, in the event of a device producing more traffic than anticipated could prompt the use of bandwidth limiting on the port of a network infrastructure device that is directly attached to it, thereby limiting the errant behavior without negatively impact legitimate traffic.

The ONE metric also can be used prognostically in an effort to predict network status and behavior in advance of a material disruption, or as an indicator of network performance and general health when attempting to optimize its functional parameters.

Consider the follow example scenarios:

1. A given network has an operating ONE range of between 91% and 94%. The ONE rises to 97% triggering an alert by the ONE device and initiation of corrective action. The ONE device and/or network administrators may localize the variation to, for example, a collection of switches within a specific network segment and unpack the ONE level, value or factor to discover that the capacity factory has reach 99%. This indicates that there is no network traffic however everything is still online, and all connections are still available. The likely conclusion is that operational traffic has ceased which would be the result of an operational shutdown or an evacuation of the area.

2. A given network has an operating ONE range of between 91% and 94%. The ONE drops to 86% triggering an alert by the ONE device and initiation of corrective action. The ONE device and/or network administrators may localize the variation to, for example, a collection of switches within a specific network segment and unpack the ONE level, value or factor to discover that the capacity factory has fallen to below 40%. This indicates that there is a significant amount of network traffic relative to the baseline. The likely conclusion is that some new or asynchronous function is occurring which is consuming additional bandwidth which hasn't started over saturated the connections enough to cause downtime, but it may be causing intermittent communication losses.

3. A given network has an operating ONE range of between 91% and 94%. The ONE drops to 72% triggering an alert by the ONE device and initiation of corrective action. The ONE device and/or network administrators may localize the variation to a collection of switches within a specific network segment and unpack the ONE level, value or factor to discover that the quality factor along the wireless access points has dropped to below 30%. This indicates that there is a problematic amount of traffic within the wireless spectrum. The likely conclusion is that there are too many client radios using the same channel or that access points using are overlapping channels.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An overall network performance effectiveness improvement device for improving overall network performance based on a network availability level, a network capacity level, and a network quality level, comprising:
an overall network performance effectiveness improvement controller having overall network performance effectiveness improvement program instructions stored in a memory device;
wherein the overall network performance effectiveness improvement controller is configured to receive network availability data, network capacity data, and network quality data regarding a network and calculate a network availability level, a network capacity level, and network quality level based on such network availability data, network capacity data, and network quality data;
wherein the overall network performance effectiveness improvement controller is configured to calculate an overall network performance effectiveness level of the network based on the calculated network availability level, the calculated network capacity level, and the calculated network quality level;
wherein the overall network effectiveness level is determined based on the calculated network availability level times the calculated network capacity level times the calculated network quality level;
wherein the overall network performance effectiveness improvement controller is configured to determine whether the calculated overall network performance effectiveness level is below a predetermined threshold overall network performance effectiveness level;
wherein the calculated network availability level comprises an available time link level that is configured to be available for use by the network during operation divided by an expected time link level that is expected to be available for use by the network during operation;
wherein the calculated network capacity level comprises an unutilized network port utilization percentage of an unutilized port level of the network relative to a utilized network port level of the network;
wherein the calculated network quality level comprises functional network packets received divided by total network packets received;
wherein the overall network performance effectiveness improvement controller is configured to cause a network improvement control event that is configured to improve overall network performance effectiveness of the network if the overall network performance effectiveness level is below a first predetermined threshold overall network performance effectiveness level;
wherein the first predetermined threshold overall network performance effectiveness level comprises an overall network performance effectiveness level indicative of an enhanced network performance level that is greater than the calculated overall network performance effectiveness level;
wherein the overall network performance effectiveness improvement controller is configured to receive updated network availability data, updated network capacity data, and updated network quality data regarding the network as a result of the network improvement control event, and calculate an updated network availability level, an updated network capacity level, and an updated network quality level based on the updated network availability data, the updated network capacity data, and the updated network quality data;
wherein the overall network performance effectiveness improvement controller is configured to calculate an updated overall network performance effectiveness level of the network based on the updated network availability data, the updated network capacity data, and the updated network quality data; and
wherein the overall network performance effectiveness improvement controller is configured to cause an updated network improvement control event that is configured to improve overall network performance effectiveness of the network if the updated overall network performance effectiveness level is below a second predetermined threshold overall network performance effectiveness level.

2. The device of claim 1, wherein the predetermined threshold overall network performance effectiveness level is 75% or higher.

3. The device of claim 1, wherein the overall network performance effectiveness improvement controller is configured to determine whether the calculated network availability level is below a predetermined threshold network availability level and cause a network availability improvement control event that is configured to improve network availability performance effectiveness if the calculated network availability level is below the predetermined threshold network availability level.

4. The device of claim 3, wherein the predetermined threshold network availability level comprises a threshold enhanced network availability level that is indicative of a network with an enhanced network availability level that is greater than the calculated network availability level.

5. The device of claim 3, wherein the predetermined threshold network availability level is 98%.

6. The device of claim 1, wherein the overall network performance effectiveness improvement controller is configured to determine whether the calculated network capacity level is below a predetermined threshold network capacity level and cause a network capacity improvement control event that is configured to improve network capacity performance effectiveness if the calculated network capacity level is below the predetermined threshold network capacity level.

7. The device of claim 6, wherein the predetermined threshold network capacity level comprises a threshold enhanced network performance capacity level that is indicative of a network with an enhanced network performance capacity level that is greater than the calculated network capacity level.

8. The device of claim 6, wherein the predetermined threshold network capacity level is 90%.

9. The device of claim 1, wherein the overall network performance effectiveness improvement controller is configured to determine whether the calculated network quality factor is below a predetermined threshold network quality level and cause a network quality improvement control event that is configured to improve network quality performance effectiveness if the calculated network quality level is below the predetermined threshold network quality level.

10. The device of claim 9, wherein the predetermined threshold network quality level comprises a threshold enhanced network performance quality level that is indicative of a network having an enhanced network performance quality level that is greater than the calculated network quality level.

11. The device of claim 9, wherein the predetermined threshold network quality level is 85%.

12. The device of claim 1, wherein the overall network performance effectiveness improvement controller is configured to calculate successive overall network performance effectiveness levels regarding the network over time and calculate an average overall network performance effectiveness level based on the calculated successive overall network performance effectiveness levels.

13. The device of claim 12, wherein the overall network performance effectiveness improvement controller is configured to cause a network quality improvement control event that is configured to improve overall network performance effectiveness if the calculated average overall network performance effectiveness level is below the predetermined average overall network performance effectiveness level.

14. The device of claim 12, wherein the overall network performance effectiveness improvement controller is configured to compare subsequent calculated overall network performance effectiveness levels to the calculated average overall network performance effectiveness level.

15. The device of claim 1, wherein the network improvement control event comprises improving a network connection or setting.

16. The device of claim 1, wherein the network improvement control event comprises improving a network availability, capacity and/or quality connection, setting, node, or link that are each configured to improve network availability, capacity, and/or quality respectively.

17. An overall network performance effectiveness improvement device for improving overall network performance based on a network availability level, a network capacity level, and a network quality level, comprising:
an overall network performance effectiveness improvement controller configured to receive network availability data, network capacity data, and network quality data regarding a network and calculate a network availability level, a network capacity level, and a network quality level based on such network availability data, network capacity data, and network quality data;
wherein the overall network performance effectiveness improvement controller is configured to calculate an overall network effectiveness level of the network based on the calculated network availability level, the calculated network capacity level, and the calculated network quality level;
wherein the overall network performance effectiveness improvement controller is configured to determine whether the calculated overall network performance effectiveness level is below a predetermined threshold overall network performance effectiveness level;
wherein the calculated network availability level comprises an available time link level that is configured to be available for use by the network during operation divided by expected time link level that is configured to be expected to be available for use by the network during operation;
wherein the calculated network capacity level comprises an unutilized network port utilization percentage of unutilized ports of the network relative to utilized ports of the network;
wherein the calculated network quality level comprises functional network packets received divided by total network packets received; and
wherein the overall network performance effectiveness improvement controller is configured to cause a network improvement control event that is configured to improve overall network performance effectiveness of the network if the overall network performance effectiveness level is below a predetermined threshold overall network performance effectiveness level.

18. The device of claim 17, wherein the predetermined threshold overall network performance effectiveness level is 75%.

19. The device of claim 17, wherein the overall network performance effectiveness improvement controller includes overall network performance effectiveness improvement program instructions stored in a memory device.

20. The device of claim 18, wherein the predetermined threshold overall network performance effectiveness level comprises a threshold network availability level indicative of a network with an enhanced network availability performance level.

21. The device of claim 20, wherein the overall network performance effectiveness improvement controller is configured to receive updated network availability data, updated network capacity data, and updated network quality data regarding the network as a result of the network improvement control action, and calculate an updated network availability level, an updated network capacity level, and/or an updated network quality level based on the updated network availability data, the updated network capacity data, and the updated network quality data, wherein the overall network performance effectiveness improvement controller is configured to calculate an updated overall network performance effectiveness level of the network, wherein the predetermined threshold overall network performance effectiveness level comprises a first predetermined threshold overall network performance effectiveness level, and wherein the overall network performance effectiveness improvement controller is configured to cause an updated network improvement control event that is configured to improve overall network performance effectiveness of the network if the updated overall network performance effectiveness level is below a second predetermined threshold overall network performance effectiveness level.

22. The device of claim 17, wherein the overall network performance effectiveness level is calculated based on the network availability factor times the network capacity factor times the network quality factor.

23. The device of claim 17, wherein the overall network performance effectiveness improvement controller is configured to determine whether the calculated network availability level is below a predetermined threshold network availability level and cause a network availability improvement control event to improve network availability performance effectiveness if the calculated network availability level is below the predetermined threshold network availability level.

24. The device of claim 23, wherein the predetermined threshold network availability level comprises a threshold network availability level indicative of a network with an enhanced performance availability level that is greater than the calculated network availability level.

25. The device of claim 23, wherein the predetermined threshold network availability level is 98%.

26. The device of claim 17, wherein the overall network performance effectiveness improvement controller is configured to determine whether the calculated network capacity level is below a predetermined threshold network capacity level and cause a network capacity improvement control event that is configured to improve network capacity performance effectiveness if the calculated network capacity level is below the predetermined threshold network capacity level.

27. The device of claim 26, wherein the predetermined threshold network capacity level comprises an enhanced threshold network performance capacity level indicative of a network with an enhanced performance capacity level that is greater than the calculated network capacity level.

28. The device of claim 26, wherein the predetermined threshold network capacity level is 90%.

29. The device of claim 17, wherein the overall network performance effectiveness improvement controller is configured to determine whether the calculated network quality factor is below a predetermined threshold network quality level and cause a network quality improvement control event that is configured to improve network quality performance effectiveness if the calculated network quality level is below the predetermined threshold network quality level.

30. The device of claim 29, wherein the predetermined threshold network quality level comprises an enhanced threshold network performance quality level indicative of a network having an enhanced network performance quality level that is greater than the calculated network quality level.

31. The device of claim 29, wherein the predetermined threshold network quality level is 85%.

32. The device of claim 17, wherein the overall network performance effectiveness improvement controller is configured to calculate successive overall network performance effectiveness levels regarding the network over time, calculate an average overall network performance effectiveness level based on the calculated successive overall network performance effectiveness levels, and cause a network performance improvement event that is configured to improve the overall performance of the network based on the calculated average overall network performance effectiveness level.

33. The device of claim 17, wherein the overall network performance effectiveness improvement controller is configured to cause an overall network effectiveness improvement control event that is configured to improve overall network performance effectiveness if the calculated average overall network performance effectiveness level is below the predetermined average overall network performance effectiveness level.

34. The device of claim 17, wherein the overall network performance effectiveness improvement controller is configured to compare subsequent calculated overall network performance effectiveness levels to the calculated average overall network performance effectiveness level, calculate a subsequent-to-calculated-average overall network performance effective level comparison, and cause an overall network effectiveness improvement control event that is configured to improve overall network performance effectiveness based on the calculated subsequent-to-calculated-average overall network performance effective level comparison.

35. The device of claim 17, wherein the network improvement control event comprises improving a connection, setting, switch, node, link, configuration, and/or state of the network that that are each configured to improve network availability, capacity, and/or quality respectively.

36. An overall network performance effectiveness improvement device for improving overall network performance based on a network availability level, a network capacity level, and a network quality level, comprising:
an overall network performance effectiveness improvement controller configured to receive network availability data, network capacity data, and network quality data regarding a network and calculate a network availability level, a network capacity level, and a network quality level based on such network availability data, network capacity data, and network quality data;
wherein the overall network performance effectiveness improvement controller is configured to calculate an overall network performance effectiveness level of the network based on the calculated network availability level, the calculated network capacity level, and the calculated network quality level;
wherein the overall network performance effectiveness improvement controller is configured to determine whether the calculated overall network performance effectiveness level is below a predetermined threshold overall network performance effectiveness level; and
wherein the overall network performance effectiveness improvement controller is configured to cause a network improvement control event that is configured to improve overall network performance effectiveness of the network if the overall network performance effectiveness level is below a predetermined threshold overall network performance effectiveness level.

37. The device of claim 36, wherein the predetermined threshold overall network performance effectiveness level is 75% or higher.

38. The device of claim 36, wherein the calculated network availability level comprises time links available for the network divided by time links expected to be available for the network, the calculated network capacity level comprises unutilized network port utilization percentage, and the calculated network quality level comprises functional network packets received divided by total network packets received.

39. The device of claim 36, wherein the overall network performance effectiveness improvement controller includes overall network performance effectiveness improvement program instructions stored in a memory device, and wherein the predetermined threshold overall network performance effectiveness level comprises an overall network performance effectiveness level indicative of network that is configured to perform at an enhanced network performance level that is greater than the calculated overall network performance effectiveness level.

40. The device of claim 36, wherein the overall network performance effectiveness improvement controller is configured to receive updated network availability data, updated network capacity data, and updated network quality data regarding the network as a result of the network improvement control action, and calculate an updated network availability level, an updated network capacity level, and an updated network quality level based on the updated network availability data, the updated network capacity data, and the updated network quality data, wherein the overall network performance effectiveness improvement controller is configured to calculate an updated overall network performance effectiveness level of the network, wherein the predetermined threshold overall network performance effectiveness level comprises a first predetermined threshold overall network performance effectiveness level, wherein the overall network performance effectiveness improvement controller is configured to generate an updated network improvement control action that is configured to improve overall network performance effectiveness of the network if the updated overall network performance effectiveness level is below a second predetermined threshold overall network performance effectiveness level, and wherein the overall network performance effectiveness level is calculated based on the network availability level times the network capacity level times the network quality level.

41. The device of claim 36, wherein the overall network performance effectiveness improvement controller is configured to determine whether the calculated network availability level is below a predetermined threshold network availability level, and generate a network availability improvement control action to improve network availability performance effectiveness if the calculated network availability level is below the predetermined threshold network availability level, and wherein the predetermined threshold network availability level comprises an enhanced network availability level that is greater than the calculated network availability level.

42. The device of claim 41, wherein the predetermined threshold network availability level is 98%.

43. The device of claim 36, wherein the overall network performance effectiveness improvement controller is configured to determine whether the calculated network capacity level is below a predetermined threshold network capacity level, and generate a network capacity improvement control action to improve network capacity performance effectiveness if the calculated network capacity level is below the predetermined threshold network capacity level, and wherein the predetermined threshold network capacity level comprises an enhanced network capacity level that is greater than the calculated network capacity level.

44. The device of claim 43, wherein the predetermined threshold network capacity level is 90%.

45. The device of claim 36, wherein the overall network performance effectiveness improvement controller is configured to determine whether the calculated network quality factor is below a predetermined threshold network quality level, and generate a network quality improvement control action to improve network quality performance effectiveness if the calculated network quality level is below the predetermined threshold network quality level, and wherein the predetermined threshold network quality level comprises an enhanced network quality level that is greater than the calculated network capacity level.

46. The device of claim 45, wherein the predetermined threshold network capacity level is 90%.

47. The device of claim 36, wherein the overall network performance effectiveness improvement controller is configured to calculate successive overall network performance effectiveness levels regarding the network over time, calculate an average overall network performance effectiveness level based on the calculated successive overall network performance effectiveness levels and cause a network performance improvement event that is configured to improve the overall performance of the network based on the calculated average overall network performance effectiveness level.

48. The device of claim 36, wherein the overall network performance effectiveness improvement controller is configured to generate an overall network effectiveness improvement control action to improve overall network performance effectiveness if the calculated average overall network performance effectiveness level is below the predetermined average overall network performance effectiveness level.

49. The device of claim 36, wherein the overall network performance effectiveness improvement controller is configured to compare subsequent calculated overall network performance effectiveness levels to the calculated average overall network performance effectiveness level, calculate a subsequent-to-calculated-average overall network performance effective level comparison, and cause an overall network effectiveness improvement control event that is configured to improve overall network performance effectiveness based on the calculated subsequent-to-calculated-average overall network performance effective level comparison.

50. The device of claim 36, wherein the network improvement control event comprises improving a connection, setting, switch, node, link, configuration, and/or state of the network that that are each configured to improve network availability, capacity, and/or quality respectively.
